(19) United States
(12) Patent Application Publication
(10) Pub. No.: US 2015/0310373 A1
(43) Pub. Date: Oct. 29, 2015

(54) SYSTEM AND METHOD FOR DESIGNING SERVICES DELIVERING VALUE TO STAKEHOLDERS

(71) Applicant: Tata Consultancy Services Limited, Mumbai (IN)

(72) Inventors: Anand KUMAR, Pune (IN); Doji Samson LOKKU, Madhapur-Hyderabad (IN); Nikhil Ravindranath ZOPE, Mumbai (IN)

(21) Appl. No.: 14/633,345

(22) Filed: Feb. 27, 2015

(30) Foreign Application Priority Data
Feb. 27, 2014 (IN) 694/MUM/2014

(51) Int. Cl. G06Q 10/06

(52) U.S. Cl. CPC G06Q 10/06395

(57) ABSTRACT

Disclosed is a system for designing one or more services delivering value to one or more stakeholders. The identification module may identify one or more stakeholders associated with a service. The process determination module determines one or more existing processes implemented by the one or more stakeholders for creating a value associated to the service. The value determination module determines a list of values pertaining to the service. The service quality retrieving module retrieve a plurality of service qualities and a plurality of process qualities from a service quality master list and a process quality master list respectively. The correlation module correlates each value, present in the list of values, with the plurality of service qualities in order to identify one or more service qualities of the plurality of service qualities. The service definition module defines a service breakdown structure and a process breakdown structure associated with the service.

### CROSS-REFERENCE TO RELATED APPLICATIONS AND PRIORITY

The present application claims priority to Indian Patent Application No. 694/MUM/2014, filed on Feb. 27, 2014, the entirety of which is hereby incorporated by reference.

### TECHNICAL FIELD

The present disclosure described herein, in general, relates to a system and method for design of a service, more particularly relates to designing of the service based on combination of value and quality.

### BACKGROUND

A service industry, also called the tertiary sector, is one of the three parts of the economy. Service industry faces lot of challenges in meeting varying customer demands thereby maintaining quality. Also, in various competitive scenarios, the service providing industry should regularly improve and update the services in order to improve the growth of the respective service providing industry. A service is the result of interactions between different role players and service components which could be social, technological and cultural elements. The service sector provides the service in intangible nature, not an actual product that could be held in hand or felt. Because of the intangible nature of the service, it is difficult to describe the service; making the service least understood. Also, while rendering and consuming the service there is no transfer of possession or ownership. It is the experience of the consumer who consumes the service for a specific instance that makes the service valuable at the time of consumption. When the service is consumed repeatedly by the consumer then the consistency in experience makes the service valuable.

Formlessness is one more form in which the service exists as the service may be experienced in any form by the consumer. Due to the formless nature of the service, almost all the service sectors are complex, incomplete, defective, and non-standardized. The service provided by the service sector cannot be physically stored, seen or processed as consumption of the services is often simultaneous with production of the services and the services do not require further processing. As a result of this formlessness, it becomes difficult for the service providers to describe the services and make consumer see value in it before the actual service is rendered to the consumer.

The main problem in the existing systems is that the service providers should have a better hand on value delivered by the services provided by them so that the consumers will have more knowledge about superior services. However, there is less clarity on the extent of the value experienced and delivery processes of the service that assures the value and various other aspects related to the service that create the value. This lack of the clarity is due to the fact that there are no well-defined service design methodologies to assure the value of the service and other aspects of the services. Moreover, most of the traditional service design methodologies are implicitly product design methodologies and require tweaking to apply in a servicing situation. Further, neither the consumers nor the service providers are able to have the clarity on the value creation system for the services provided by them. Hence, pre-analysis of a service because of its intangible nature, remains a difficult task before the service is rendered.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods for designing one or more services delivering value to one, or more stakeholders and the concepts are further described below in the detailed description. This summary is not intended to identify essential features of the disclosure nor is it intended for use in determining or limiting the scope of the disclosure.

In one implementation, a system for designing one or more services delivering value to one or more stakeholders is disclosed. In one aspect, the system may comprise a processor and a memory coupled to the processor. The processor may execute a plurality of modules present in the memory. The plurality of modules may comprise an identification module, a process determination module, a value determination module, a service quality retrieving module, a correlation module, and a service definition module. The identification module may identify one or more stakeholders associated with a service. The process determination module may determine one or more existing processes implemented by the one or more stakeholders for creating a value associated to the service. The value determination module may determine a list of values pertaining to the service based on the one or more stakeholders and the one or more existing processes. The service quality retrieving module may retrieve a plurality of service qualities and a plurality of process qualities from a service quality master list and a process quality master list respectively. In one aspect, the plurality of service qualities and the plurality of process qualities may be retrieved based on Service Level Agreement (SLA). The correlation module may correlate each value, present in the list of values, with the plurality of service qualities in order to identify one or more service qualities of the plurality of service qualities. The one or more service qualities indicate a quality specification for the service. The service definition module may define a service breakdown structure and a process breakdown structure associated with the service. The service breakdown structure may comprise a hierarchy of sub-services forming the service. The process breakdown structure may comprise a hierarchy of sub-processes forming a process to deliver the service. In one aspect, each sub-service may be delivered with at least one service quality present in the quality specification.

In one implementation, a method for designing one or more services delivering value to one or more stakeholders is disclosed. In order to design the one or more services, initially, one or more stakeholders associated with a service may be identified. Upon identifying the one or more stakeholders, one or more existing processes implemented by the one or more stakeholders may be determined for creating a value associated to the service. Subsequent to the determination of the one or more existing processes, a list of values pertaining to the service may be determined based on the one or more stakeholders and the one or more existing processes. After determining the list of values, a plurality of service qualities and a plurality of process qualities may be retrieved from a service quality master list and a process quality master list respectively. In one aspect, the plurality of service qualities and the plurality of process qualities may be retrieved based on Service Level Agreement (SLA). Subsequently, each value, present in the list of values, may be correlated with the plurality of service qualities in order to identify one or more service qualities of the plurality of service qualities. The one or more service qualities indicate a quality specification for the service. After the correlation, a service breakdown structure and a process breakdown structure associated with the service may be defined. In one aspect, the service breakdown structure may comprise a hierarchy of sub-services forming the service. The process breakdown structure may comprise a hierarchy of sub-processes forming a process to deliver the service. In one aspect, each sub-service is to be delivered with at least one service quality present in the quality specification. In one aspect, the aforementioned method for designing one or more services delivering value to one or more stakeholders is performed by using a processor using programmed instructions stored in a memory.

In yet another implementation, non-transitory computer readable medium embodying a program executable in a computing device for designing one or more services delivering value to one or more stakeholders is disclosed. The program may comprise a program code for identifying one or more stakeholders associated with a service. The program may comprise a program code for determining one or more existing processes implemented by the one or more stakeholders for creating a value associated to the service. The program may comprise a program code for determining a list of values pertaining to the service based on the one or more stakeholders and the one or more existing processes. The program may comprise a program code for retrieving a plurality of service qualities and a plurality of process qualities from a service quality master list and a process quality master list respectively, wherein the plurality of service qualities and the plurality of process qualities may be retrieved based on Service Level Agreement (SLA). The program may comprise a program code for correlating each value, present in the list of values, with the plurality of service qualities in order to identify one or more service qualities, of the plurality of service qualities, wherein the one or more service qualities indicate a quality specification for the service. The program may comprise a program code for defining a service breakdown structure and a process breakdown structure associated with the service, wherein the service breakdown structure comprises a hierarchy of sub-services forming the service, and wherein the process breakdown structure comprises a hierarchy of sub-processes forming a process to deliver the service, and wherein each sub-service is to be delivered with at least one service quality present in the quality specification.

### BRIEF DESCRIPTION OF THE DRAWINGS

The foregoing summary as well as detailed description of embodiments of the present disclosure is better understood when read in conjunction with the appended drawings. For the purpose of illustrating the disclosure, there is shown in the present document example constructions of the disclosure; however, the disclosure is not limited to the specific methods and apparatus disclosed in the document and the drawings.

FIG. 1 illustrates a network implementation of a system for designing one or more services delivering value to one or more stakeholders, in accordance with an embodiment of the present disclosure.

FIG. 2 illustrates the system, in accordance with an embodiment of the present subject matter.

FIGS. 3, 4(a)-4(b), and 5(a)-5(b) illustrate examples, in accordance with an embodiment of the present disclosure.

FIG. 6 illustrates a method for designing the one or more services delivering value to one or more stakeholders, in accordance with an embodiment of the present disclosure.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

System(s) and Method(s) for designing one or more services delivering value to one or more stakeholders are disclosed. The present system and method provides a comprehensive collaborative environment for designing the one or more services. Under the comprehensive collaborative environment, the present system and method facilitates to utilize a value viewpoint approach that serves as the underlying theme for developing and thereby delivering the one or more services. The comprehensive collaborative environment utilizes (i) the value delivered by a service provided by a service provider to a service consumer; (ii) a quality characteristics engineered into the service by the service provider and (iii) a correlation between the value and the quality as the bridge to successful design of the one or more services, development of the one or more services and delivery of the one or more services.

Before delivering the value to the one or more stakeholders, the present system and method determines various insights based on four questions that needs to be answered for the service to succeed economically. These four questions are:

1) What are the benefits and who are the beneficiaries of the one or more services.

Insights: Anyone who gets affected by a service or participates in it in any way is a beneficiary. For the service to be beneficial to someone, it is necessary to determine the benefits in terms of (1) usefulness in satisfying a consumer need, (2) relative importance of the need being satisfied, (3) availability relative to when it is needed, and (4) the cost of ownership. These economic considerations indicate the satisfaction of the service consumer and the service consumer's ability to satisfy their purposes.

2) How these benefits are realized and what are the enablers for achieving the benefits?

Insights: The expectations of the service, in terms of delivering benefits, should exhibit the appropriate service quality characteristics. The service quality characteristics determine how well a service delivery is able to create benefits for the service consumer and further define how the service addresses a given scenario. In order to obtain the service of good quality, a plurality of quality attributes is generally considered for delivering the benefits. The plurality of quality attributes may include maintainability, portability, testability, traceability, correctness, and robustness.

3) What is the underlying form of the service that enables benefits achievement?

Insights: The services design deals with the design and delivery of the service and is the assembly of number of service components in some well-chosen forms to satisfy the functional and non-functional quality characteristics of the service. The process of creating a service specification starts with understanding the quality characteristics, value creation context and specific situation; diagnosing it using archetypes, patterns and existing models; and synthesizing an approximate symbolic (or) mathematical (or) conceptual (or) physical representation. In summary, the service description is a multi-faceted artefact produced by the design process and composed of relatively independent and orthogonal facets/models of the service. Thus, above are considered to enable the benefits when the service is being delivered to the service consumer.

4) How does a service consumer realize this benefits delivering service?

Insights: The value and the quality requirements may be used to verify and validate the various service components and their interconnections. The feedback to above questions may be then used in the next iteration of the service design cycle, particularly when problems or challenges are identified. In one aspect, the service is the output that is created by the service delivery process, wherein the service transforms the design inputs to an acceptable output and may be characterized by the quality attributes that are of value to the service consumers. When the service is consumed, it creates the value and related experience to the service consumers and thus realizes the benefits the service being delivered.

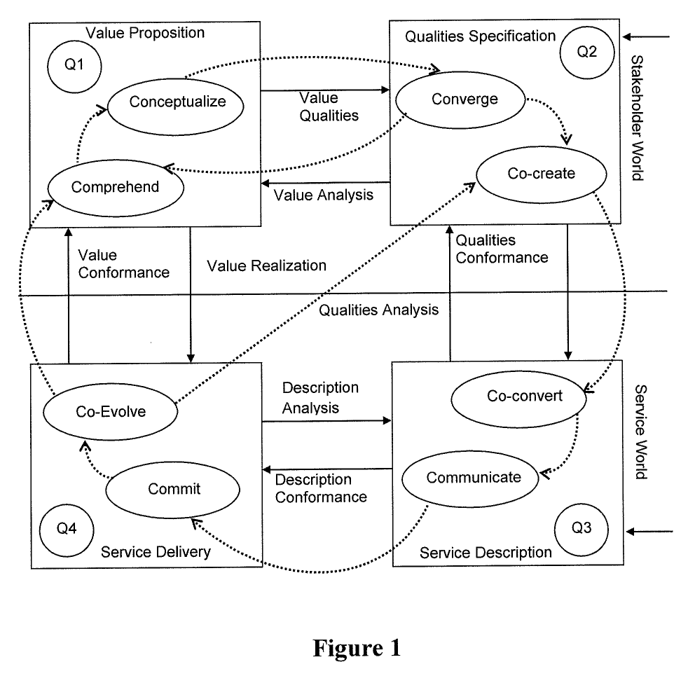

In one embodiment, the insights obtained from answering the above four questions serve as four different interrelated perspectives as illustrated in FIG. 1. Out of the four perspectives, two perspectives focus on stakeholders' perspective and remaining two perspectives focus on service world perspective. The stakeholder perspectives are ‘value to stakeholders’ that is delivered by the service when consumed and the ‘quality characteristics’ that is built into the service so to deliver the desired value. On the other hand, the service world perspectives are the ‘Service Description’. The ‘Service Description’ is the specification of the service and the ‘Service Delivery’ which is the instantiated design for the particular situation context. The combination of the four perspectives and the interrelationships provide a structure that enables the designer to design one or more services delivering value to one or more stakeholders.

In one aspect, the present system and method utilizes the four perspectives and their interrelationships delivering the value to the one or more stakeholders. The value is delivered by, initially, identifying the one or more stakeholders associated with the service. Examples of the stakeholders may include, but not limited to, provider side stakeholders, consumer stakeholders, and product marketing stakeholders. Upon identifying the one or more stakeholders, one or more existing processes implemented by the one or more stakeholders may be determined for creating the value associated to the service.

Subsequent to the determination of the one or more existing processes, a list of values pertaining to the service may be. The list of values may comprise reliability, responsiveness, assurance, competence, credibility, communication, understanding, consulting, price, consulting, and Geographic's. After determining the list of values, plurality of service qualities and a plurality of process qualities may be retrieved from a service quality master list and a process quality master list respectively. Subsequently, each value, present in the list of values, may be correlated with the plurality of service qualities in order to identify one or more service qualities of the plurality of service qualities. In one aspect, the one or more service qualities indicate a quality specification for the service. After the correlation, a service breakdown structure and a process breakdown structure associated with the service may be defined. In one aspect, the service breakdown structure may comprise a hierarchy of sub-services forming the service. The process breakdown structure, on the other hand, may comprise a hierarchy of sub-processes forming a process to deliver the service. In one aspect, each sub-service is to be delivered with at least one service quality present in the quality specification.

In other words, with reference to the aforementioned description, it may be understood that the present invention facilitates to determine value proposition based on identification of a stakeholder of the one or more stakeholders, understanding the value creation context pertaining to the stakeholder, understanding situation context, defining problem space, defining service space, and defining service value creation context. The present invention further determines the qualities specification that supports redefining value requirements pertaining to the stakeholder, defining service configuration, defining service quality characteristics and correlation to the value, developing the service breakdown structure and the quality breakdown structure, and developing usage processes. The present invention further determines the service description by identifying design styles, defining design rationales, defining design models, developing appropriate views and viewpoints, generating service descriptions. The present invention further facilitates to realize the service to be delivered. In one aspect, the service is realized based on service delivery, service analysis and improvement, quality analysis and improvement, and value analysis and improvement.

In addition to the above, the present invention further facilitates mapping of the value and the quality. The mapping involves value analysis, quality conformance, quality analysis, service description conformance, service description analysis, value realization, and value conformance. Further the present invention facilitates a service workbench functionality that provides packaging of service design tools, collaboration, coordination and networking, invocation and interoperation of service design tools, exchange of information between service design tools, and manipulation of information by various service design tools. Along with the service workbench functionality, the present invention further facilitates modelling functionality, model interpreter functionality, integration functionality, exchange server functionality, configuration functionality, decision support functionality, wizard functionality, and run-time functionality.

In one aspect, the modelling functionality provides information modelling, process modelling, Graphical User Interface (GUI) modelling, presentation modelling, situation modelling, requirements modelling, and capability extension modelling. The model interpreter functionality provides process interpretation and execution, presentation interpretation and generation, requirements interpretation, data model interpretation, and GUI model interpretation. The integration functionality provides data integration, functionality or capability integration, features integration, and reports integration. The exchange server functionality provides information exchange between various tools, view point exchange, generating multiple views, ability to work on multiple views, and project information manipulated in a view on the unified information model. The configuration functionality provides capability configuration and process configuration. The decision support functionality provides decision analysis and decision formulation. The wizard functionality provides information gathering and process flow and sequencing. The run-time functionality provides common capabilities to the workbench and tools.

Thus, based on the aforementioned methodology and functionalities of the system, the one or more services may be designed to deliver the value to the one or more stakeholders.

While aspects of described system and method for designing one or more services delivering value to one or more stakeholders may be implemented in any number of different computing systems, environments, and/or configurations, the embodiments are described in the context of the following exemplary system.

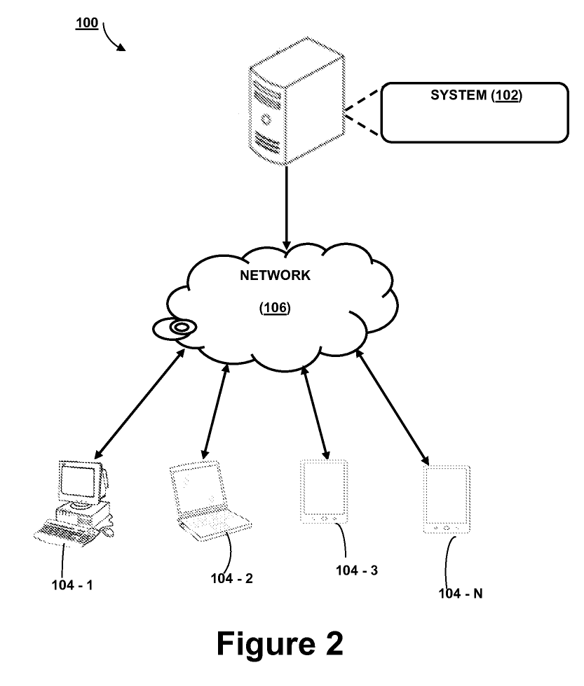

Referring now to FIG. 2, a network implementation 100 of a system 102 for designing one or more services delivering value to one or more stakeholders is disclosed. In order to identify the one or more web elements that lead to value delivery, initially, one or more stakeholders associated with a service may be identified. Upon identifying the one or more stakeholders, the system 102 determines one or more existing processes implemented by the one or more stakeholders for creating the value associated to the service. Subsequent to the determination of the one or more existing processes, the system 102 determines a list of values pertaining to the service. After determining the list of values, the system 102 retrieves a plurality of service qualities and a plurality of process qualities may be retrieved from a service quality master list and a process quality master list respectively. Subsequently, the system 102 correlates each value, present in the list of values, with the plurality of service qualities in order to identify one or more service qualities of the plurality of service qualities. The one or more service qualities indicate a quality specification for the service. After the correlation, the system 102 defines a service breakdown structure and a process breakdown structure associated with the service. In one aspect, the service breakdown structure may comprise a hierarchy of sub-services forming the service. The process breakdown structure may comprise a hierarchy of sub-processes forming a process to deliver the service. In one aspect, each sub-service is to be delivered with at least one service quality present in the quality specification.

Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment and the like. It will be understood that the system 102 may be accessed by multiple users through one or more user devices 104-1, 104-2 . . . 104-N, collectively referred to as user devices 104 hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

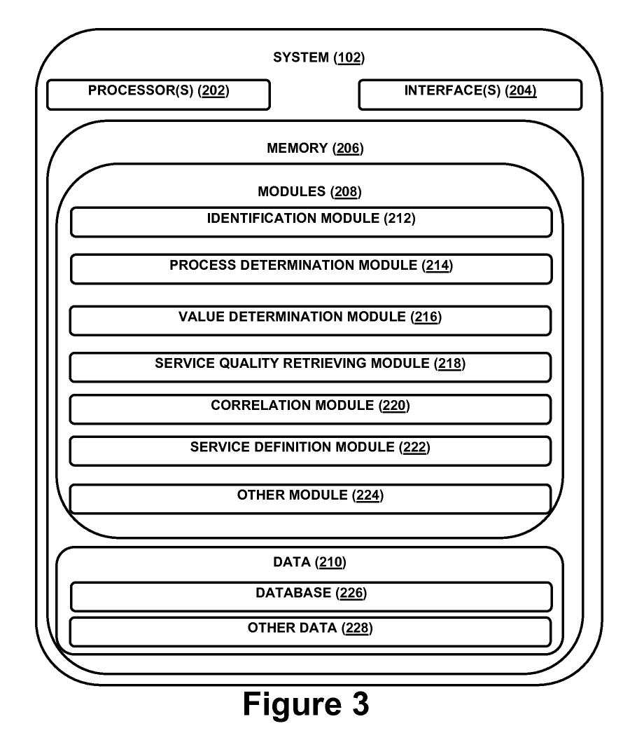

Referring now to FIG. 3, the system 102 is illustrated in accordance with an embodiment of the present disclosure. In one embodiment, the system 102 may include a processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208, other modules 210 and data 210.

The modules 208 include routines, programs, objects, components, data structures, etc., which perform particular tasks or implement particular abstract data types. In one implementation, the modules 208 may include an identification module 212, a process determination module 214, a value determination module 216, a service quality retrieving module 218, a correlation module 220, a service definition module 222, and other modules 224. The modules 208 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a database 226 and other data 228. The other data 228 may include data generated as a result of the execution of one or more modules in the other modules 224.

In one implementation, at first, a user may use the client devices 104 to access the system 102 via the I/O interface 204. The user may register themselves using the I/O interface 204 in order to use the system 102. In one aspect, the user may accesses the I/O interface 204 of the system 102 for designing one or more services delivering value to one or more stakeholders. The system 102 provides a comprehensive collaborative environment for designing the one or more services. Under the comprehensive collaborative environment, the system 102 is configured to utilize a value viewpoint approach that serves as the underlying theme for developing the one or more services, and delivering the one or more services. In one aspect, the value indicates a measure of worth (for example, benefit divided by cost) of a service provided to one or more stakeholders. Further, the value is a function of (1) the service's usefulness in satisfying a customer need, (2) the relative importance of the need being satisfied, (3) the availability of the service relative to when it is needed, and (4) the cost of ownership to the consumer. The measure of worth and the functions contributes significantly to the one or more stakeholders in terms of achieving their goals, plans, improvements, developments needed for growth are considered as appealing to the one or more stakeholder serves as the perceived possible value.

In one aspect, the comprehensive collaborative environment utilizes the value delivered by a service, of the one or more services, provided by a service provider to the one or more stakeholders; a quality characteristics engineered into the service by the service provider and a correlation between the value and the quality as the bridge for successfully designing, development and delivery of the one or more services. In order to deliver the one or more services, the system 102 may employ the plurality of modules i.e. the identification module 212, the process determination module 214, the value determination module 216, the service quality retrieving module 218, the correlation module 220, and the service designing module 222. The detailed working of the plurality of modules is described below.

The identification module 212 identifies one or more stakeholders associated with a service. The one or more stakeholders may include, but not limited to, provider side stakeholders, consumer stakeholders, and product marketing stakeholders. Upon identification of the one or more stakeholders, the process determination module 214 determines one or more existing processes implemented by the one or more stakeholders. In one aspect, the one or more existing processes may be determined for creating the value associated to the service. In one aspect, the value may delivered in terms on demand delivery, on time delivery, increase effectiveness, productivity and throughput, within budget, no additional costs, less waste in terms of bottlenecks and inefficiencies, less business latency, experience certainty, reduce cost and enhance value. Subsequent to the determination of the one or more existing processes, the value determination module 216 determines a list of values pertaining to the service based on the one or more stakeholders and the one or more existing processes. The list of values may include, but not limited to reliability, responsiveness, assurance, competence, credibility, communication, understanding, consulting, price, consulting, and Geographic's.

After determining the list of values, the service quality retrieving module 218 retrieves a plurality of service qualities and a plurality of process qualities from a service quality master list and a process quality master list respectively. In one aspect, the service quality master list and the process quality master list are stored in a database 226. It may be understood that the plurality of service qualities and the plurality of process qualities may be retrieved based on Service Level Agreement (SLA). Subsequent to the determination of the list of values, the correlation module 220 correlates each value, present in the list of values, with the plurality of service qualities. In one aspect, each value may be correlated to identify one or more service qualities of the plurality of service qualities. The one or more service qualities indicate a quality specification for the service to be delivered to the one or more stakeholders.

Based on the correlation of each value with the plurality of service qualities, the service definition module 222 defines a service breakdown structure and a process breakdown structure associated with the service. The service breakdown structure may comprise a hierarchy of sub-services forming the service. The process breakdown structure, on the hand, may comprise a hierarchy of sub-processes forming a process to deliver the service. It may be understood that each sub-service to be delivered with at least one service quality is present in the quality specification.

In order to understand the designing of the one or more services for the one or more stakeholders (hereinafter referred to as a consumer), consider an example where the service providers, responsible for managing price changes pertaining to a plurality of commodities, generally face the problem to design the workflow for temporary price change in IT enabled services. Even though the service offered by different service providers is acceptable to the service consumer, every service provider has their own notion of how to organize their processes for delivering the service. This is due to factors like differing perception and interpretation of the service, difference in the usage of information systems, competency, effort, dexterity, consistency, etc. The problem situation under consideration is:

Retailers like ‘ABC’ sells commodities in huge numbers every day. The retailer's Information Technology (IT) are capable of storing data such as inventory, sales, suppliers, customers, receivables, payables, offers, discounts, etc. To cater growing competition in the markets, ‘ABC’ retailer may announce discounts so as to provide offers and adopt traditional marketing practices for increasing the sales. All these decisions were percolated to the IT systems of the retailers and reflected in information related to millions of commodities. Since the amount of the data is huge, a lot of human efforts and cost are involved in making changes in the existing IT systems of the retailers. In order to reduce the cost involved in such manual efforts, the ‘ABC’ retailer may outsource the work to BPO companies. Typically, in the outsourced company, data validation team identifies changes to be made, transaction team make these changes in customers' IT systems and quality team checks and validates the transactions. The service consumers i.e. the ‘ABC’ retailer expect 100% confidentiality and 9×4 (99.99%) levels of accuracy from the service provider (i.e. BPO companies) while performing the transactions (such as temporary price change) in the IT systems of the ‘ABC’ retailer. As part of the service delivery, BPO companies perform quality audits, supervise, sign off transactions and perform significant rework for delivering the value to the ‘ABC’ retailer.

In order to design the one or more services delivering the value, one or more stakeholders associated with a service are identified. It may be understood that the one or more stakeholders are either service provider side stakeholders or service consumer side stakeholders or both. The service consumer side stakeholders are transacting agent, manager, transaction quality assurance team, infrastructure supports team, service provider organization. The service consumer side stakeholders, on the other hand, are marketing team (that fixes the commodity price), service manager, service quality assurance team, infrastructure support team, service consumer organization.

In this servicing situation, the ‘ABC’ retailer outsources the ‘temporary price change’ activity to the BPO companies in order to reduce cost. Over multiple iterations they would like to continuously reduce the cost of price change. Therefore ‘reduce cost’ in performing the price change is one of the values in which the service consumers are mostly interested. Further consider the service is delivered on schedule then service consumers may start discount offers exactly at the time they want to without any delay at negligible costs. Therefore ‘enhance value’ is another value for the ‘ABC’ retailers' business in which the service consumers are also interested.

Based on determination of the value (′reduce cost′ and ‘enhance value’), some of the value creation context for the value in the delivery of the service are identified. The value creation context includes on demand delivery, on time delivery, increase effectiveness, productivity and throughput, within budget, no additional costs, less waste in terms of bottlenecks and inefficiencies, less business latency, experience certainty. It may be understood that the service provider may offer a service that has many qualities. However, not all of them might be valuable for the service consumers. Some of them might be trivial, some of them non-interesting and some of them delightful. In order to select a set of qualities that are valuable to the service consumers, the service providers need to correlate the value with the set of qualities. For example, table 1 illustrates the correlation between the value and the set of qualities.

| Value | Quality |
|---|---|
| Reduce Cost | Competence, Reliability, Credibility, Price |
| Enhance Value | Understanding, Assurance, Communication, |
| | Responsiveness, Consulting |

In one aspect, ‘Competence’ indicates possess necessary skills and knowledge to perform price change in customers systems, ‘Reliability’ indicates ability to perform the services dependably and accurately, ‘Credibility’ indicates trustworthiness and believability (Confidentiality of the transacted data), ‘Price’ indicates transaction based pricing model, ‘Understanding’ indicates Understands the implications of the price change for the commodity, ‘Assurance’ indicates Service personnel's knowledge and courtesy, ‘Communication’ indicates keeps the consumers informed on the progress, ‘Responsiveness’ indicates willingness to help and provide prompt service, and ‘Consulting’ indicates ability to align with customer's operations.

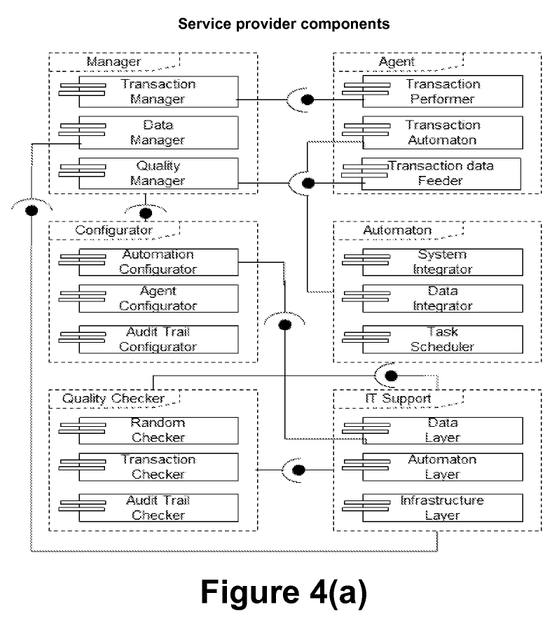

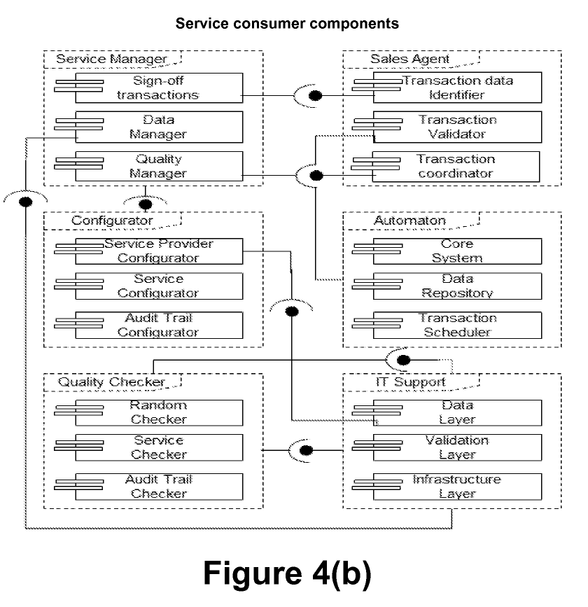

Upon correlating the value with the set of qualities, a service breakdown structure and a process breakdown structure associated with the service are defined. In order to understand the service breakdown structure as a whole, multiple views are necessary, with each view defining a set of properties corresponding to respective concerns. For illustration purposes a provider view and a consumer view for the service are shown in FIGS. 4(a) and 4(b) respectively. Each view is a different perspective in representing the service and explains how the service can be understood, analyzed and synthesized.

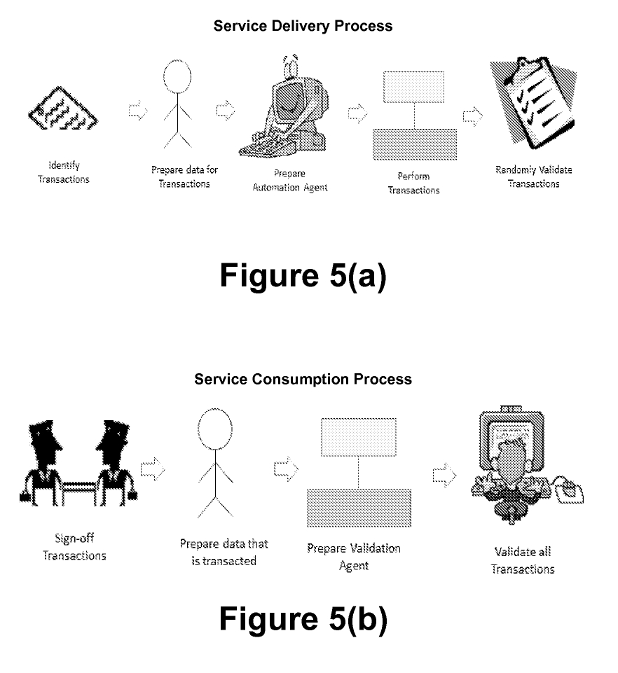

The process breakdown structure, on the other hand, defines breakdown of each process to be followed in order to accomplish the quality for the service to be delivered to the service consumers. In one aspect, service processes are the way a service is delivered and consumed by the service consumers. While the actual action is performed by the service providers and the service consumers, the sequence of steps to be invoked are the service processes. In one aspect, the service processes are designed in a manner such that the different service components coordinate together and manifest the desired qualities. In one example, FIGS. 5(a) and 5(b) illustrate the service processes. It may be understood that the service breakdown structure comprises a hierarchy of sub-services forming the service and the process breakdown structure comprises a hierarchy of sub-processes forming a process to deliver the service. Each sub-service is to be delivered with at least one service quality present in the quality specification. Thus, based on the quality specification, the system 102 facilitates to design the one or more services for delivering the value to the one or more stakeholders.

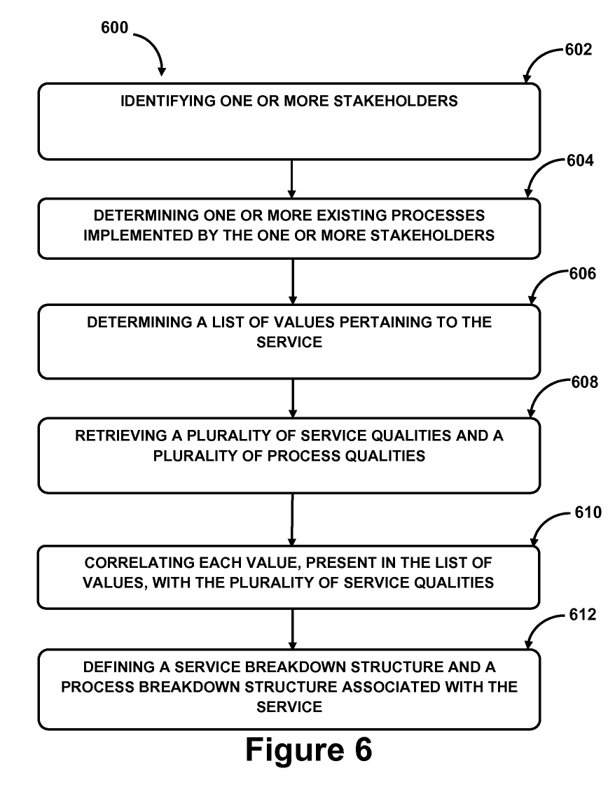

Referring now to FIG. 6, a method 600 for designing one or more services delivering value to one or more stakeholders is shown, in accordance with an embodiment of the present disclosure. The method 600 may be described in the general context of computer executable instructions. Generally, computer executable instructions can include routines, programs, objects, components, data structures, procedures, modules, functions, etc., that perform particular functions or implement particular abstract data types. The method 600 may be practiced in a distributed computing environment where functions are performed by remote processing devices that are linked through a communications network. In a distributed computing environment, computer executable instructions may be located in both local and remote computer storage media, including memory storage devices.

The order in which the method 600 is described is not intended to be construed as a limitation, and any number of the described method blocks can be combined in any order to implement the method 600 or alternate methods. Additionally, individual blocks may be deleted from the method 600 without departing from the spirit and scope of the disclosure described herein. Furthermore, the method can be implemented in any suitable hardware, software, firmware, or combination thereof. However, for ease of explanation, in the embodiments described below, the method 600 may be considered to be implemented in the above described in the system 102.

At block 602, one or more stakeholders associated with a service may be identified. In one implementation, one or more stakeholders associated with a service may be identified by the identification module 212.

At block 604, one or more existing processes implemented by the one or more stakeholders for creating a value associated to the service may be determined. In one implementation, the one or more existing processes may be determined by the process determination module 214.

At block 606, a list of values pertaining to the service may be determined. In one aspect, the list of values may be determined based on the one or more stakeholders and the one or more existing processes. In one implementation, the list of values pertaining to the service may be determined by the value determination module 216.

At block 608, a plurality of service qualities and a plurality of process qualities may be retrieved from a service quality master list and a process quality master list respectively. In one aspect, the plurality of service qualities and the plurality of service process qualities may be retrieved based on Service Level Agreement (SLA). In one implementation, the plurality of service qualities and the plurality of process qualities may be retrieved by the service quality retrieving module 218.

At block 610, each value, present in the list of values may be correlated with the plurality of service qualities in order to identify one or more service qualities of the plurality of service qualities. In one aspect, the one or more service qualities indicate a quality specification for the service. In one implementation, each value may be correlated with the plurality of service qualities by the correlation module 220.

At block 612, a service breakdown structure and a process breakdown structure associated with the service may be designed. In one aspect, the service breakdown structure may comprise a hierarchy of sub-services forming the service and the process breakdown structure may comprise a hierarchy of sub-processes forming a process to deliver the service. In one aspect, each sub-service may be delivered with at least one service quality present in the quality specification. In one implementation, the service breakdown structure and the process breakdown structure may be designed by the service designing module.

Exemplary embodiments discussed above may provide certain advantages. Though not required to practice aspects of the disclosure, these advantages may include those provided by the following features.

Some embodiments enable a system and a method to identify all of those stakeholders who get affected by the service to be delivered to the service consumer by the service provider.

Some embodiments enable a system and a method to facilitate to understand value creation processes of the stakeholders and how the stakeholders perform their work processes to deliver outcomes.

Some embodiments enable service designers to accumulate knowledge of the problem domain and the serviceable situation based on processes by which provider stakeholders add the value to the service consumers.

Some embodiments enable a system and a method to identify the essential and distinguishing attributes that deliver the intended value to be delivered.

Some embodiments enable a system and a method to facilitate traceability of quality characteristics and value as well as traceability of service description with service expectations.

Although implementations for methods and systems for designing one or more services delivering value to one or more stakeholders have been described in language specific to structural features and/or methods, it is to be understood that the appended claims are not necessarily limited to the specific features or methods described. Rather, the specific features and methods are disclosed as examples of implementations for designing the one or more services delivering the value to the one or more stakeholders.

We claim:

1. A method for designing one or more services delivering value to one or more stakeholders, the method comprising:
identifying, using a processor, one or more stakeholders associated with a service;
determining, using the processor, one or more existing processes implemented by the one or more stakeholders for creating a value associated to the service;
determining, using the processor, a list of values pertaining to the service based on the one or more stakeholders and the one or more existing processes;
retrieving, using the processor, a plurality of service qualities and a plurality of process qualities from a service quality master list and a process quality master list respectively, wherein the plurality of service qualities and the plurality of service process qualities are retrieved based on Service Level Agreement (SLA);
correlating, using the processor, each value, present in the list of values, with the plurality of service qualities in order to identify one or more service qualities, of the plurality of service qualities, wherein the one or more service qualities indicate a quality specification for the service; and
defining, using the processor, a service breakdown structure and a process breakdown structure associated with the service, wherein the service breakdown structure comprises a hierarchy of sub-services forming the service, and wherein the process breakdown structure comprises a hierarchy of sub-processes forming a process to deliver the service, and wherein each sub-service is to be delivered with at least one service quality present in the quality specification.

2. The method of claim 1, wherein the stakeholders are at least one of provider side stakeholders, consumer stakeholders, and product marketing stakeholders.

3. The method of claim 1, wherein the list of values comprises reliability, responsiveness, assurance, competence, credibility, communication, understanding, consulting, price, consulting, and Geographic's.

4. The method of claim 1, wherein the value comprises on demand, on time delivery, increase effectiveness, productivity and throughput, within budget, no additional costs, less waste in terms of bottlenecks and inefficiencies, less business latency, experience certainty, reduce cost and enhance value.

5. A system for designing one or more services delivering value to one or more stakeholders, the system comprising:
a processor; and
a memory coupled to the processor, wherein the processor is capable of executing a plurality of modules stored in the memory, and wherein the plurality of modules comprising:
an identification module for identifying one or more stakeholders associated with a service;
a process determination module for determining one or more existing processes implemented by the one or more stakeholders for creating a value associated to the service;
a value determination module for determining a list of values pertaining to the service based on the one or more stakeholders and the one or more existing processes;
a service quality retrieving module for retrieving a plurality of service qualities and a plurality of process qualities from a service quality master list and a process quality master list respectively, wherein the plurality of service qualities and the plurality of process qualities are retrieved based on Service Level Agreement (SLA);
a correlation module for correlating each value, present in the list of values, with the plurality of service qualities in order to identify one or more service qualities, of the plurality of service qualities, wherein the one or more service qualities indicate a quality specification for the service; and
a service definition module for defining a service breakdown structure and a process breakdown structure associated with the service, wherein the service breakdown structure comprises a hierarchy of sub-services forming the service, and wherein the process breakdown structure comprises a hierarchy of sub-processes forming a process to deliver the service, and wherein each sub-service, to be delivered with at least one service quality, is present in the quality specification.

6. The system of claim 5, wherein the stakeholders are at least one of provider side stakeholders, consumer side stakeholders, and product marketing stakeholders.

7. The system of claim 5, wherein the list of values comprises reliability, responsiveness, assurance, competence, credibility, communication, understanding, consulting, price, consulting, and Geographic's.

8. The system of claim 5, wherein the value comprises on demand, on time delivery, increase effectiveness, productivity and throughput, within budget, no additional costs, less waste in terms of bottlenecks and inefficiencies, less business latency, experience certainty, reduce cost and enhance value.

9. A non-transitory computer readable medium embodying a program executable in a computing device for designing one or more services delivering value to one or more stakeholders, the program comprising a program code:
a program code for identifying one or more stakeholders associated with a service;
a program code for determining one or more existing processes implemented by the one or more stakeholders for creating a value associated to the service;
a program code for determining a list of values pertaining to the service based on the one or more stakeholders and the one or more existing processes;
a program code for retrieving a plurality of service qualities and a plurality of process qualities from a service quality master list and a process quality master list respectively, wherein the plurality of service qualities and the plurality of process qualities are retrieved based on Service Level Agreement (SLA);
a program code for correlating each value, present in the list of values, with the plurality of service qualities in order to identify one or more service qualities, of the plurality of service qualities, wherein the one or more service qualities indicate a quality specification for the service; and
a program code for defining a service breakdown structure and a process breakdown structure associated with the service, wherein the service breakdown structure comprises a hierarchy of sub-services forming the service, and wherein the process breakdown structure comprises a hierarchy of sub-processes forming a process to deliver the service, and wherein each sub-service is to be delivered with at least one service quality present in the quality specification.
